(19) United States
(12) Patent Application Publication
(10) Pub. No.: US 2024/0380502 A1
(43) Pub. Date: Nov. 14, 2024

(54) WIRELESS COMMUNICATION METHOD, WIRELESS COMMUNICATION SYSTEM, AND WIRELESS COMMUNICATION DEVICE

(71) Applicant: NIPPON TELEGRAPH AND TELEPHONE CORPORATION, Tokyo (JP)

(72) Inventors: Keita KURIYAMA, Musashino-shi, Tokyo (JP); Hayato FUKUZONO, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/291,232

(22) PCT Filed: Aug. 4, 2021
(86) PCT No.: PCT/JP2021/028956

§ 371 Date: Jan. 23, 2024

(51) Int. Cl. H04B 17/309; H04L 5/14; H04W 56/00

(52) U.S. Cl. CPC H04B 17/346; H04L 5/1469; H04W 56/0015

(57) ABSTRACT

A radio communication method including detecting an SNR of a line performing radio communication, and determining whether or not there is a margin of a predetermined value or more in the detected SNR for each line with respect to a required SNR of the line performing radio communication. Further, there is a changing of a frame configuration for each line to shorten a frame length within a range of the required SNR or more even when the SNR is degraded for the line determined to have a margin of a predetermined value or more, and executing processing to perform radio communication by the frame configuration changed for each line via the line determined to have a margin of a predetermined value or more.

### TECHNICAL FIELD

The present invention relates to a radio communication method, a radio communication system, and a radio communication device.

### BACKGROUND ART

As a radio communication system, for example, a system in which a subscriber station accommodating a plurality of voice lines and a base station connected to a network perform time division duplex (TDD) radio communication to achieve two-way voice communication is known.

Further, PTL 1 discloses an adaptive modulation type radio communication method in which the number of communicating lines is observed, the quality of each communication is observed, and a modulation scheme is determined so that a modulation order is minimized while the observed quality of each communication satisfies the required quality on the basis of the observed number of lines, the observed quality of each communication, and a required throughput of each line.

### CITATION LIST

### Patent Literature

[PTL 1] Japanese Patent Application Publication No. 2020-198594

### SUMMARY OF INVENTION

### Technical Problem

However, conventionally, even if a signal to noise ratio (SNR) of a data signal to be transmitted is large, communication using low-order modulation with a small required SNR and a small throughput may be performed, and even if the required communication quality is satisfied, a delay may occur.

The present invention has been made in view of the above-mentioned problems, and an object of the present invention is to provide a radio communication method, a radio communication system, and a radio communication device capable of reducing a delay while communication quality is effectively improved.

### Solution to Problem

A radio communication method according to one aspect of the present invention is a radio communication method in which radio communication is performed by a radio communication device capable of accommodating a plurality of lines, the radio communication method including: an SNR detection step of detecting an SNR of a line performing radio communication; a margin determination step of determining whether or not there is a margin of a predetermined value or more in the detected SNR for each line with respect to a required SNR of the line performing radio communication; a frame configuration changing step of changing a frame configuration for each line to shorten a frame length within a range of the required SNR or more even when the SNR is degraded for the line determined to have a margin of a predetermined value or more; and a radio communication processing step of executing processing to perform radio communication by the frame configuration changed for each line via the line determined to have a margin of a predetermined value or more.

Further, a radio communication system according to one aspect of the present invention is a radio communication system in which radio communication is performed by a radio communication device capable of accommodating a plurality of lines, the radio communication system including: an SNR detection unit that detects an SNR of a line performing radio communication; a margin determination unit that determines whether or not there is a margin of a predetermined value or more in the SNR detected by the SNR detection unit for each line with respect to a required SNR of the line performing radio communication; a frame configuration changing unit that changes a frame configuration for each line to shorten a frame length within a range of the required SNR or more even when the SNR is degraded for the line determined by the margin determination unit to have a margin of a predetermined value or more; and a radio communication processing unit that executes processing to perform radio communication by the frame configuration changed by the frame configuration changing unit for each line via the line determined by the margin determination unit to have a margin of a predetermined value or more.

Further, a radio communication device according to one aspect of the present invention is a radio communication device capable of accommodating a plurality of lines, the radio communication device including: an SNR detection unit that detects an SNR of a line performing radio communication; a margin determination unit that determines whether or not there is a margin of a predetermined value or more in the SNR detected by the SNR detection unit for each line with respect to a required SNR of the line performing radio communication; a frame configuration changing unit that changes a frame configuration for each line to shorten a frame length within a range of the required SNR or more even when the SNR is degraded for the line determined by the margin determination unit to have a margin of a predetermined value or more; and a radio communication processing unit that executes processing to perform radio communication by the frame configuration changed by the frame configuration changing unit for each line via the line determined by the margin determination unit to have a margin of a predetermined value or more.

### Advantageous Effects of Invention

According to the present invention, a delay can be reduced while communication quality is effectively improved.

### BRIEF DESCRIPTION OF DRAWINGS

FIG. 1 is a diagram illustrating a configuration example of a radio communication system according to an embodiment.

FIG. 2 is a functional block diagram illustrating functions of a radio communication device according to an embodiment.

FIG. 3 is a diagram illustrating options of a modulation scheme determined by a determination unit.

FIG. 4(a) is a diagram schematically illustrating a frame configuration example when a margin determination unit determines that there is no margin of a predetermined value or more, and FIG. 4(b) is a diagram schematically illustrating a frame configuration example when a margin determination unit determines that there is a margin of a predetermined value or more.

### DESCRIPTION OF EMBODIMENTS

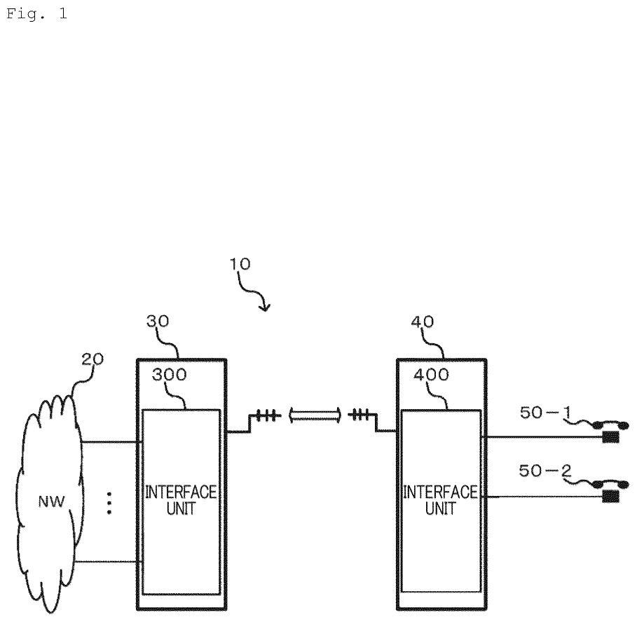

Hereinafter, an embodiment of a radio communication system will be described with reference to the drawings. FIG. 1 is a diagram illustrating a configuration example of a radio communication system 10 according to an embodiment. As illustrated in FIG. 1, the radio communication system 10 is, for example, a digital subscriber-based radio system including a base station 30 connected to a network 20 and a subscriber station 40 that performs two-way radio communication such as voice communication with the base station 30.

The radio communication system 10 is not limited to accommodating a voice line, and may be a system that accommodates a data communication line as long as it performs digital radio communication.

The base station 30 is a radio communication device in which an interface unit 300 provided therein is connected to the network 20 and has functions of a transmitter and a receiver. The interface unit 300 performs control such that a signal inside the base station 30 interfaces with a signal outside the base station 30.

The subscriber station 40 is a radio communication device in which an interface unit 400 provided therein is connected to, for example, a plurality of telephone terminals 50-1 and 50-2 and has functions of a transmitter and a receiver. The interface unit 400 performs control such that a signal inside the subscriber station 40 interfaces with a signal outside the subscriber station 40.

Then, the subscriber station 40 performs radio communication with the base station 30 by changing the modulation scheme according to the number of lines making a call by the telephone terminals 50-1 and 50-2 and the like and radio communication quality of SNR and the like and changing the frame configuration according to the number of lines making a call.

Next, a more specific configuration and operation example of the subscriber station 40 will be described. It is assumed that the base station 30 also has substantially the same configuration as the subscriber station 40.

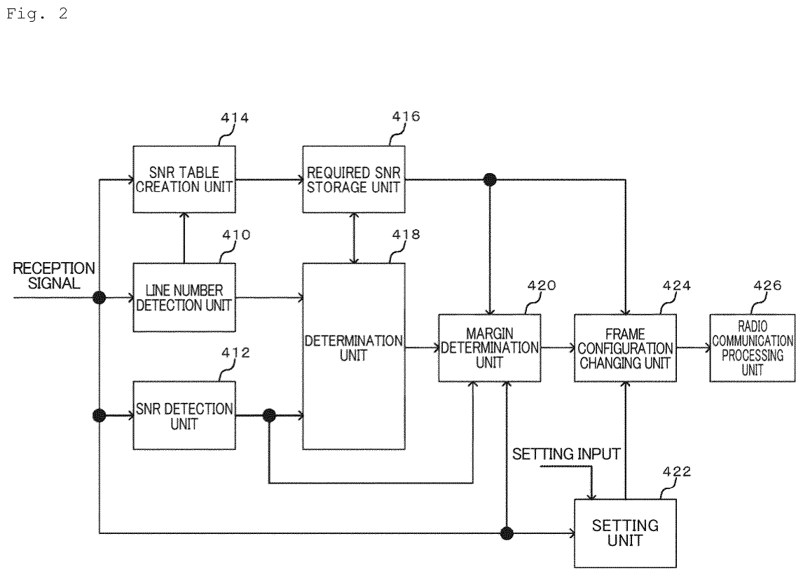

FIG. 2 is a functional block diagram illustrating functions of the subscriber station 40 according to an embodiment. As illustrated in FIG. 2, the subscriber station 40 includes, for example, a line number detection unit 410, an SNR detection unit 412, an SNR table creation unit 414, a required SNR storage unit 416, a determination unit 418, a margin determination unit 420, a setting unit 422, a frame configuration changing unit 424, and a radio communication processing unit 426.

The line number detection unit 410 detects the number of lines communicating simultaneously (for example, calls occurring at the same time) from the signal input to the subscriber station 40 and outputs the detected number of lines to the SNR table creation unit 414 and the determination unit 418.

The SNR detection unit 412 detects an SNR of the signal input to the subscriber station 40 through a line performing radio communication, and outputs the SNR to the determination unit 418 and the margin determination unit 420.

The SNR table creation unit 414 creates an SNR table for each number of lines detected by the line number detection unit 410 when the telephone terminals 50-1 and 50-2 are not making a call, and outputs the SNR table to the required SNR storage unit 416.

For example, it is assumed that the SNR table is a table in which the base station 30 uses a known signal transmitted by changing the training signal length, the number of slots, and the number of synchronization words (SW) by a predetermined step value (to be described later) and the SNR table creation unit 414 associates each change in the known signal (change in each parameter) with the SNR after equalizing (compensating for) each changed known signal. The SNR table includes a required SNR in each modulation scheme corresponding to the number of lines used by the subscriber station 40.

The required SNR storage unit 416 stores the SNR table created by the SNR table creation unit 414, and outputs the stored information according to access from each of the determination unit 418, the margin determination unit 420, and the frame configuration changing unit 424.

The determination unit 418 determines a modulation scheme for signal transmission on the basis of the number of lines detected by the line number detection unit 410, the SNR of each signal detected by the SNR detection unit 412, the required SNR, etc. according to the number of lines stored in the required SNR storage unit 416, and the required throughput of each of a plurality of lines, and outputs a determined result to the margin determination unit 420. Modulation schemes include, for example, quadrature phase shift keying (QPSK) in which one symbol has 4 values, 16 quadrature amplitude modulation (QAM) in 16 values, and 64QAM in 64 values.

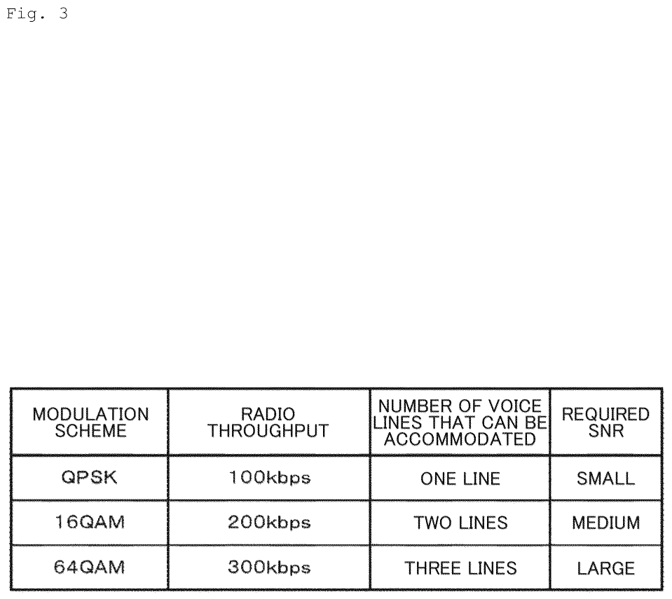

FIG. 3 is a diagram illustrating options of the modulation scheme determined by the determination unit 418. As illustrated in FIG. 3, for example, in the case of modulation by QPSK, the radio throughput is 100 kbps, and the number of voice lines which can be accommodated while satisfying the required SNR is one. In the case of modulation by 16QAM, the radio throughput is 200 kbps, and the number of voice lines which can be accommodated while satisfying the required SNR is two. In the case of modulation by 64QAM, the radio throughput is 300 kbps, and the number of voice lines which can be accommodated while satisfying the required SNR is three. As illustrated in FIG. 3, a value of the required SNR decreases as the number of lines (the number of connected lines) performing radio communication decreases.

These modulation schemes have a characteristic that when the order of the modulation scheme is lowered, the number of lines which can be accommodated while satisfying the required SNR is reduced, but the communication quality is improved. Therefore, when the radio throughput is excessively large with respect to the required throughput of the line, the determination unit 418 lowers the modulation order to low-order modulation (QPSK, etc.) to stabilize the communication quality at a high level.

Further, the determination unit 418 determines a modulation scheme so that the modulation order is minimized while the SNR of each communication detected by, for example, the SNR detection unit 412 satisfies the required SNR. The information indicating the required throughput of each of the plurality of lines is stored, for example, in the required SNR storage unit 416.

The margin determination unit 420 determines whether or not there is a margin of a predetermined value or more in the SNR detected by the SNR detection unit 412 for each line in the modulation scheme determined by the determination unit 418 with respect to the required SNR stored in the required SNR storage unit 416 of the line performing radio communication, and outputs a determination result to the frame configuration changing unit 424.

The setting unit 422 sets a step value (increment of change amount) by which the frame configuration changing unit 424 changes the training signal length, the number of slots, the number of synchronization words, and the gap time (TDD gap) in advance, for example, according to an operator's setting input.

Further, the setting unit 422 may set the shortest gap time by which the synchronization word at the end of the slot can be correctly demodulated by using a known signal transmitted by the base station 30 while gradually changing the gap time using a predetermined step value.

That is, the setting unit 422 sets the shortest gap time at which collision between an uplink signal and a downlink signal can be avoided.

The frame configuration changing unit 424 changes a frame configuration for each line to shorten a frame length within a range of the required SNR or more even when the SNR is degraded for the line determined by the margin determination unit 420 to have a margin of a predetermined value or more, and outputs the changed frame configuration to the radio communication processing unit 426.

For example, when any one of telephone terminals 50-1 and 50-2 or the like starts a call and the margin determination unit 420 determines that there is a margin of a predetermined value or more, the frame configuration changing unit 424 changes the frame configuration (combination of settings) so that the processing delay is, for example, the shortest, among the items satisfying the required SNR in the SNR table created by the required SNR storage unit 416, and outputs the changed frame configuration to the radio communication processing unit 426.

Specifically, the frame configuration changing unit 424 changes the frame configuration to shorten the frame length by reducing at least one of a training signal length, the number of slots, the number of synchronization words, and a gap time for a time division duplex frame.

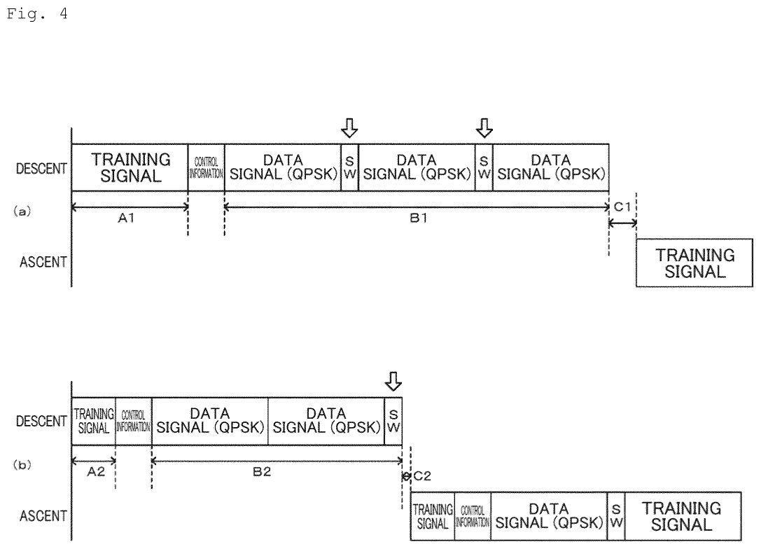

FIG. 4 is a diagram illustrating a configuration example of a frame received by the subscriber station 40. FIG. 4(a) is a diagram schematically illustrating a frame configuration example when the margin determination unit 420 determines that there is no margin of a predetermined value or more. FIG. 4(b) is a diagram schematically illustrating a frame configuration example when the margin determination unit 420 determines that there is a margin of a predetermined value or more.

The frame configuration illustrated in FIG. 4(a) is a frame configuration in which the frame configuration changing unit 424 does not change the frame configuration.

As illustrated in FIG. 4(b), when the margin determination unit 420 determines that there is a margin of a predetermined value or more, the frame configuration changing unit 424 allows at least one of the following cons and performs any of (1) to (3) to change the frame configuration.

(1) Shorten the training signal length (A1>A2).
(pros) A processing delay in the radio communication processing unit 426 or the like can be reduced.
(cons) The SNR may be degraded due to channel estimation errors.

(2) Reduce the number of slots and the number of synchronization words (SW) (B1>B2).
(pros) A delay due to buffer processing in the radio communication processing unit 426 or the like can be reduced.
(cons) The frequency of updating the tap coefficient of the equalizer is reduced, and the SNR may be degraded.

(3) Shorten the gap time (C1>C2).
(pros) A processing delay in the radio communication processing unit 426 or the like can be reduced.
(cons) Signals may not be correctly received due to collision between an uplink signal and a downlink signal.

Then, the radio communication processing unit 426 executes processing to perform radio communication by the frame configuration changed by the frame configuration changing unit 424 for each line via the line determined by the margin determination unit 420 to have a margin of a predetermined value or more.

In other words, the frame configuration changing unit 424 sets, to the radio communication processing unit 426, a frame configuration that satisfies the required SNR (or satisfies the required quality of a packet error rate (PER)) and that has the shortest processing delay when the radio communication processing unit 426 performs radio communication.

In the radio communication system 10, for example, when the telephone terminal 50-1 is busy and the telephone terminal 50-2 is not busy, if the frame configuration changing unit 424 does not change the frame configuration, communication is performed by low-order modulation with a small required SNR even if the SNR of the signal received by the subscriber station 40 is large.

However, for example, when the telephone terminal 50-1 is busy and the telephone terminal 50-2 is not busy, the radio communication system 10 allows the above-mentioned cons and the frame configuration changing unit 424 can change the frame configuration, thereby reducing a delay while communication quality is effectively improved. That is, the radio communication system 10 can perform voice communication with low delay by reducing transmission delay, and voice quality is improved.

The radio communication system 10 is not limited to accommodating a voice line, and may be a system that accommodates a data communication line. Further, the radio communication system 10 can reduce a delay while communication quality is effectively improved regardless of a radio communication standard.

Further, each unit constituting the base station 30 and the subscriber station 40 in the above-described embodiment may be configured partially or wholly by hardware, or may be configured by causing a processor to execute a program.

In addition, when each unit constituting the base station 30 and the subscriber station 40 is partially or wholly configured by causing a processor to execute a program, the program may be recorded on a recording medium and provided, or may be provided via a network.

### REFERENCE SIGNS LIST

10 Radio communication system
20 Network
30 Base station
40 Subscriber station
50-1, 50-2 Telephone terminal
300, 400 Interface unit
410 Line number detection unit
412 SNR detection unit
414 SNR table creation unit
416 Required SNR storage unit
418 Determination unit
420 Margin determination unit
422 Setting unit
424 Frame configuration changing unit
426 Radio communication processing unit

1. A radio communication method, comprising:
detecting an SNR of a line performing radio communication of a plurality of lines;
determining whether or not there is a margin of a predetermined value or more in the detected SNR for each of the lines with respect to a required SNR of the line performing radio communication;
changing a frame configuration for each line to shorten a frame length within a range of the required SNR or more even when the SNR is degraded for the line determined to have a margin of a predetermined value or more; and
executing processing to perform radio communication by the frame configuration changed for each line via the line determined to have a margin of a predetermined value or more.

2. The radio communication method according to claim 1, wherein:
the required SNR has a smaller value as a number of lines performing radio communication decreases.

3. The radio communication method according to claim 1, wherein the changing includes:
changing the frame configuration to shorten the frame length by reducing at least one of a training signal length, a number of slots, a number of synchronization words, and a gap time for a time division duplex frame.

4. A radio communication system, comprising:
SNR detection circuitry configured to detect an SNR of a line performing radio communication of a plurality of lines;
margin determination circuity configured to determine whether or not there is a margin of a predetermined value or more in the SNR detected by the SNR detection circuitry for each line with respect to a required SNR of the line performing radio communication;
frame configuration changing circuitry configured to change a frame configuration for each line to shorten a frame length within a range of the required SNR or more even when the SNR is degraded for the line determined by the margin determination circuity to have a margin of a predetermined value or more; and
radio communication processing circuitry configured to execute processing to perform radio communication by the frame configuration changed by the frame configuration changing circuitry for each line via the line determined by the margin determination circuitry to have a margin of a predetermined value or more.

5. The radio communication system according to claim 4, wherein the required SNR
has a smaller value as a number of lines performing radio communication decreases.

6. The radio communication system according to claim 4, wherein:
the frame configuration changing circuitry changes the frame configuration to shorten the frame length by reducing at least one of a training signal length, the number of slots, the number of synchronization words, and a gap time for a time division duplex frame.

7. A radio communication device, comprising:
SNR detection circuitry configured to detect an SNR of a line performing radio communication of a plurality of lines;
margin determination circuitry configured to determine whether or not there is a margin of a predetermined value or more in the SNR detected by the SNR detection circuitry for each line with respect to a required SNR of the line performing radio communication;
frame configuration changing circuitry configured to change a frame configuration for each line to shorten a frame length within a range of the required SNR or more even when the SNR is degraded for the line determined by the margin determination circuitry to have a margin of a predetermined value or more; and
radio communication processing circuitry configured to execute processing to perform radio communication by the frame configuration changed by the frame configuration changing circuitry for each line via the line determined by the margin determination circuitry to have a margin of a predetermined value or more.

8. The radio communication device according to claim 7, wherein:
the required SNR has a smaller value as the number of lines performing radio communication decreases.
